(19) United States
(12) Patent Application Publication
(10) Pub. No.: US 2025/0312996 A1
(43) Pub. Date: Oct. 9, 2025

(54) MACHINE DIRECTION ORIENTED FILM FOR TEAR AND LAMINATES THEREOF

(71) Applicant: AMCOR FLEXIBLES NORTH AMERICA, INC., Neenah, WI (US)

(72) Inventors: Melissa K. Coolich, Hortonville, WI (US); Marcelo B. Elias, Appleton, WI (US); Ross K. Gruetzmacher, Neenah, WI (US); Kevin J. Curie, Appleton, WI (US)

(21) Appl. No.: 18/864,815

(22) PCT Filed: May 31, 2022
(86) PCT No.: PCT/US2022/031598

§ 371 Date: Nov. 11, 2024

(51) Int. Cl. B32B 27/08; B32B 7/12; B32B 27/32

(52) U.S. Cl. CPC B32B 27/08; B32B 7/12; B32B 27/32; B32B 2250/02; B32B 2250/03; B32B 2250/242; B32B 2255/10; B32B 2255/26; B32B 2270/00; B32B 2307/308; B32B 2307/31; B32B 2307/516; B32B 2307/558; B32B 2307/582; B32B 2307/72; B32B 2307/7376; B32B 2553/00

(57) ABSTRACT

A multilayer film having a first surface layer of polyethylene or polypropylene polymer, a tear layer comprising between 70% to 95%, by weight, of a continuous phase polyethylene polymer, and between 5% and 30%, by weight, of one or more of a dispersed phase olefinic polymer selected from the group of poly butylene, polypropylene, cyclic olefin copolymer, EVOH and ionomer, and optionally a second surface layer of polyethylene or polypropylene polymer. The multilayer film is oriented in the machine direction and is characterized by a ratio of a transverse direction Elmendorf tear strength to a machine direction Elmendorf tear strength greater than 10. The multilayer film may have a sealing layer added to form a laminate and the laminate may be used to form a packaged product.

### TECHNICAL FIELD

This disclosure is related to machine direction oriented multilayer films that exhibit specific machine direction tear properties, laminates that contain said multilayer films and packaged products formed from the laminates.

### BACKGROUND

Polymeric films having directional tear properties can be useful in applications such as packaging films. A film that tears cleanly, easily, and consistently straight can offer various features for packaging films, such as venting characteristics or means for easy opening. In the past, tearing properties of polymeric films have been manipulated by a wide variety of means such as film thickness, film structure, orientation, and scoring.

As packaging films with high olefin content become desirable from a recycling standpoint, the physical properties of packaging films may shift. Tear properties can be drastically different as the olefinic polymers do not lend themselves to low tear resistance. Additionally, many olefinic polymers are more difficult to laser score as compared to polar polymers, further complicating incorporation of tear features into packaging films and packages.

Orientation of polymeric films can have an influence on the mechanical properties, such as puncture strength, COF, stiffness and tear resistance. Specifically, machine direction orientation has been used to decrease the tear resistance of a film in the machine direction. HDPE rich films that have been machine direction oriented can have reduced machine direction tear strength, but not sufficiently low to induce linear tear when combined with conventional low seal initiation temperature sealant films. Significant decreases in tear resistance have been achieved by adding inorganic additives to machine direction oriented film. However, these films often suffer from appearance issue because of cavitation induced haze. Additionally, the tear may remain jagged in feel and appearance.

### SUMMARY

Disclosed herein are multilayer films, laminate films including the multilayer films and packaged products formed from the laminate films. Each of these articles benefits from the respective specific elements in terms of polyolefin/polyethylene content, directional tear properties and haze properties. Various combinations of these superior features have not been demonstrated in the prior art.

The multilayer film described herein include a first surface layer including polyethylene or polypropylene polymer and a tear layer. The tear layer includes in a range of from 70% to 95%, by weight, of a continuous phase polyethylene polymer, and in a range of from 5% to 30%, by weight, of one or more of a dispersed phase olefinic polymer selected from the group of polybutylene, polypropylene, cyclic olefin copolymer, EVOH and ionomer. The tear layer has a thickness a thickness in a range of from 60% to 90% of the total thickness of the multilayer film. The multilayer film is oriented in the machine direction and a ratio of a transverse direction Elmendorf tear strength of the multilayer film to a machine direction Elmendorf tear strength of the multilayer film is greater than 10, Elmendorf tear strength measured according to ASTM D1922.

Some embodiments of the multilayer film have a first surface layer including a polyethylene having a density in a range of from 0.918 g/cm³ to 0.970 g/cm³ or a polypropylene homopolymer.

The multilayer film may also include a second surface layer including a polyethylene or polypropylene polymer. The second surface layer may include a polyethylene having a density in a range of from 0.918 g/cm³ to 0.970 g/cm³ or a polypropylene homopolymer.

In some embodiments of the multilayer film, the continuous phase polyethylene polymer of the tear layer is a medium-density polyethylene. In some embodiments of the multilayer film, the continuous phase polyethylene polymer has a melt flow index less than or equal to 3.0 g/10 min, according to ASTMD1238 (190° C./2.16 kg).

The multilayer film may have a free shrink value of less than 10% in both the machine direction and the transverse direction when tested according to ASTM D2732 using bath temperature of 90° C.

Some embodiments of the multilayer film may have tear properties wherein the ratio of the transverse direction Elmendorf tear to the machine direction Elmendorf tear is greater than 20. Some embodiments will have haze less than 15% when measured according to ASTM D1003.

The multilayer film may have a total composition that includes a polyolefin content in a range of from 95% to 100%, by weight. The total composition of the multilayer film may include a polyethylene content in a range of from 85% to 100%, by weight.

Some embodiments of the multilayer film may have a total thickness in a range of from 0.75 mil (19.1 micron) to 3.5 mil (88.9 micron), a first surface layer comprising a high-density polyethylene and having a thickness in a range of from 5% to 20%, by volume, of the total thickness, a second surface layer comprising a high-density polyethylene and having a thickness in a range of from 5% to 20%, by volume, of the total thickness and a tear layer located between the first surface layer and the second surface layer. The tear layer includes in a range of from 70% to 95%, by weight, of a continuous phase medium-density polyethylene or a continuous phase high-density polyethylene, and in a range of from 5% to 30%, by weight, of one or more of a dispersed phase olefinic polymer selected from the group of polybutylene, polypropylene, cyclic olefin copolymer, EVOH and ionomer. The multilayer film is oriented in the machine direction and a ratio of a transverse direction Elmendorf tear strength of the multilayer film to a machine direction Elmendorf tear strength of the multilayer film is greater than 10, Elmendorf tear strength measured according to ASTM D1922.

Some laminate films disclosed herein include a multilayer film and a sealing layer selected from one of a heat seal coating or a cold seal blend. The sealing layer may be coextensive with the multilayer film or patterned with regard to the multilayer film.

Other laminate films disclosed herein include a multilayer film, a sealing film comprising a sealing layer and an adhesive layer located between the multilayer film and the sealing film. The adhesive layer may be in direct contact with the multilayer film and the sealing film. The bond strength when separating the multilayer film from the sealing film is greater than 200 g/in, as measured using ASTM F904.

In some embodiments of the laminate film, the sealing film has a normalized peak load impact strength of less than 0.5 N/micron, according to ASTM D7192. The laminate film may have a normalized peak load impact strength in a range of from 10 N/mil to 15 N/mil (0.39 N/micron to 0.59 N/micron), according to ASTM D1792.

Some embodiments of the laminate film have a machine direction Elmendorf tear value less than 150 g and a ratio of a transverse direction Elmendorf tear strength of the multilayer film to a machine direction Elmendorf tear strength of the multilayer film greater than 2, Elmendorf tear strength measured according to ASTM D1922. The laminate film may further include a weakening line located in at least one of the multilayer film and the sealing film. The laminate film may be free from a weakening line.

The laminate film may have a total composition comprising a polyolefin content in a range of from 95% to 100%, by weight. The laminate film may have a total composition comprising a polyethylene content in a range of from 90% to 100%, by weight.

Also discussed herein are packaged products made using the laminate film and having at least one seal bonding the sealing layer to itself and a tear initiation feature.

### BRIEF DESCRIPTION OF THE DRAWINGS

The disclosure may be more completely understood in consideration of the following detailed description of various embodiments of the disclosure in connection with the accompanying drawings, in which:

FIG. 1 is a cross-sectional view of an embodiment of a multilayer film;

FIG. 2 is a cross-sectional view of an embodiment of a multilayer film;

FIGS. 3A and 3B are cross-sectional views of an embodiment of a tear layer;

FIG. 4 is a cross-sectional view of an embodiment of a laminate film;

FIG. 5 is a plan view of the sealing layer side of an embodiment of a laminate film;

FIG. 6 is a perspective view of an embodiment of a packaged product including a laminate film;

FIG. 7 is a cross-sectional view of an embodiment of a laminate film;

FIG. 8 is a front view of an embodiment of a packaged product including a laminate film; and

FIG. 9 is a plan view of the front of an embodiment of a packaged product including a laminate film.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are multilayer machine direction oriented (MDO) films that include a high polyolefin content and superior machine direction easy tear properties. The design of the structure is reliant upon a combination of film structure, layer composition, and film orientation to achieve surprising results. Also described herein are laminates that include the easy tearing MDO films, the tear properties of the laminates also benefiting in easy tear properties. The films disclosed herein are useful in a number of applications including packaging. Packaged products of many types and various package formats may benefit from the superior tear properties, such as those that require easy venting or easy opening features. The packaged products may exhibit superior quality when tearing a portion of the package away, offering low effort and visually pleasing opening for the package.

It has been advantageously found that in order to get superior machine direction tear properties (clean, no chatter, lacing or webbing) on multilayer polyolefin films, it is necessary to not only decrease the resistance of tear propagation in the machine direction (decrease MD tear resistance) but also increase the resistance of tear propagation in the transverse direction (increase TD tear resistance). This unbalancing of tear properties was achieved by creating a tear layer having a two phase blend of slightly immiscible polymers and subjecting the film to machine direction orientation. Unexpectedly, the resulting film was found to have very low machine direction tear resistance and higher transverse direction tear resistance, while remaining very low in haze. The resulting film is highly desirable as it not only allows for easy machine direction tearing, but also has a premium quality appearance with minimal stretching along the tear propagation and very low haze.

### Definitions

The term “layer”, as used herein, refers to a building block of a film or laminate that is a structure of a single material type, a homogeneous blend of materials or a dispersion blend of materials. A layer may be a single polymer, a blend of materials within a single polymer type or a blend of various polymers, may contain metallic materials and may have additives. Layers may be continuous with the film (i.e., coextensive with the film) or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major layer surfaces. In other words, one major surface of an exterior layer is exposed. An interior layer is one that is connected to another layer at both major surfaces. In other words, an interior layer is between two other layers. A layer may have sub-layers.

Similarly, the term “film”, as used herein, refers to a web built of layers and/or films, all of which are directly adjacent to and connected to each other. A film can be described as having a thickness that is insignificant as compared to the length and width of the film. Films are generally regarded as having two major surfaces, opposite each other, expanding in the length and width directions. As used herein, a “laminate” is a film that may be built from an unlimited number of films and/or layers, the films and/or layers being bonded together by any known process such as, but not limited to, coextrusion, coating or laminating, to form a composite article.

The term “package” is used herein to describe an article that may house an object (i.e., a product), the article formed by bonding one or more laminates or other packaging components to itself or each other around a periphery, thus forming a package interior space.

As used herein, the term “exterior layer”, “exterior film”, “surface layer” or “surface film” is used to describe a film or layer that is located on one of the major surfaces of the film or laminate in which it is comprised. As used herein, the term “interior layer” or “interior film” is used to describe a film or layer that is not located on the surface of the film in which it is comprised. An interior film or layer is adjacent to another film or layer on both sides.

As used herein, the term “sealing layer” is a layer of a film that is located at an exterior surface, providing for adhesion to another surface. The sealing layer may contain materials, such as low seal temperature polymers, that are suitable to form heat seals. The sealing layer may contain materials that form seals under pressure alone, i.e., cold seal blends.

As used herein, “dispersed phase” is a portion of a blended system containing at least two phases, the portion being divided into small portions and distributed through the “continuous phase”. The continuous phase is generally only interrupted by the dispersed phase. As used in this application, both the dispersed phase and the continuous phase are polymeric in nature, and slightly immiscible such that they do not form a completely homogeneous blend throughout the layer.

As used throughout this application, the term “copolymer” refers to a polymer product obtained by the polymerization reaction or copolymerization of at least two monomer species. The term “copolymer” is also inclusive of the polymerization reaction of three, four or more monomer species having reaction products referred to terpolymers, quaterpolymers, etc. As used throughout this application, the term “homopolymer” refers to a polymer product obtained by the polymerization reaction of a single monomer species.

As used herein, the term “polyolefin” or “olefinic polymer” includes polymers derived from alkene monomers.

As used throughout this application, the term “polyethylene” or “PE” refers to, unless indicated otherwise, ethylene homopolymers or copolymers. Such copolymers of ethylene include copolymers of ethylene with other units or groups such as vinyl acetate, acid groups, acrylate groups, or otherwise. The term “polyethylene” or “PE” is used without regard to the presence or absence of substituent branch groups. Polyethylene includes, for example, medium density polyethylene, high density polyethylene, low density polyethylene, linear low-density polyethylene, ultra-low density polyethylene. ethylene alpha-olefin copolymer, ethylene vinyl acetate, ethylene acid copolymers, ethylene acrylate copolymers, cyclic olefin copolymers or blends of such. Various polyethylene polymers may be recycled as reclaimed polyethylene or reclaimed polyolefin.

As used throughout this application, the term “high-density polyethylene” or “HDPE” refers to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.940 g/cm³ to about 0.960 g/cm³. High-density polyethylene includes polymers made with Ziegler or Phillips type catalysts and polymers made with single site metallocene catalysts. The high-density polyethylene may be bimodal and may be pre-nucleated. As used throughout this application the term “medium-density polyethylene” (MDPE) refers to homopolymers and copolymers of ethylene having a density from about 0.926 g/cm³ to about 0.940 g/cm³.

As used throughout this application, the term “polypropylene” or “PP” refers to, unless indicated otherwise, propylene homopolymers or copolymers. Such copolymers of propylene include copolymers of propylene with at least one alpha-olefin and copolymers of propylene with other units or groups. The term “polypropylene” or “PP” is used without regard to the presence or absence of substituent branch groups or other modifiers. Polypropylene includes, for example, homopolymer polypropylene, polypropylene impact copolymer, polypropylene random copolymer, etc. Various polypropylene polymers may be recycled as reclaimed polypropylene or reclaimed polyolefin.

As used herein, “polybutylene”, “PB-1” or “polybutene-1” refers to a saturated polymer represented by the general formula: [(CH₂CH(CH₃))ₙ].

As used throughout this disclosure, the term “cyclic olefin copolymer” refers to polymers produced by the copolymerization of cyclic monomers with ethene. Examples of cyclic olefin copolymers includes ethylene norbornene copolymers. The properties of cyclic olefin copolymer, such as T_{g} (glass transition temperatures), may vary widely based on monomer content.

As used throughout this application, the term “ethylene vinyl alcohol copolymer”, “EVOH copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

As used throughout this application, “ionomer” refers to the ionized or partially ionized form of a copolymer of ethylene with an acrylic acid or a methacrylic acid wherein the neutralizing cation can be any suitable metal ion, such as zinc or sodium.

The term “adhesive layer,” or “tie layer,” refers to a layer or material placed on one or more layers to promote the adhesion of that layer to another surface. For example, tie layers may be positioned between two layers of a multilayer film to maintain the two layers in position relative to each other and prevent undesirable delamination. In another example, adhesive layers may be positioned between two films of a laminate to maintain the two layers in position relative to each other and prevent undesirable delamination.

As used herein, layers or films that are “in direct contact with” or “are directly adjacent to” each other have no intervening material between them.

The packages described herein include components formed from a laminate of the multilayer film. The laminates and the packages may be recyclable. As used herein, the term “recyclable” is intended to reflect that the material can be easily processed in a recycling process that accepts “all-polyethylene” articles or “all-polyolefin” articles. Typically, these recycling processes can accept low levels of some contaminant material. As such, as used herein, recyclable refers to the packaging or laminate having very high levels of polyethylene and low levels of acceptable contaminates. The total composition defined by weight of materials defines the recyclability of the packaging film. As described herein, the “total composition” of the multilayer film, laminate or packaged product refers to all components, including the panels, zipper and any other additional components except for the actual product in the package. The total composition of the multilayer film, the laminate or the package, each independently may include in a range of from 80% to 100% polyolefin or 90% to 100% polyolefin, by weight. In some embodiments, the total composition of the multilayer film, the laminate or the package, each independently is greater than 80%, or greater than 85%, or greater than 90%, or greater than 95% polyolefin, by weight. The total composition of the multilayer film, the laminate or the package, each independently may include in a range of from 85% to 100%, or 95% to 100% polyethylene, by weight. In some embodiments, the total composition of the multilayer film, the laminate or the package, each independently is greater than 85%, greater than 90%, or greater than 95% polyethylene, by weight.

As described herein, the multilayer film is machine direction oriented. Orientation may be the result of monoaxially oriented (machine direction) stretching of the film, increasing the machine direction dimension and subsequently decreasing the thickness of the material. The film is subjected to a stretching force after heating the film to a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength and barrier. Orientation is typically accomplished by an MDO process using heated rolls. A typical blown film coextrusion process does impart some stretching of the film, but not enough to be considered oriented as described herein. An oriented film may be heat set (i.e., annealed) after orientation, such that it is relatively dimensionally stable and has low free shrink under elevated temperature conditions that might be experienced during conversion of the multilayer film (i.e., printing or laminating) or during the use of the resulting laminate (i.e., heat sealing).

The films described herein are produced by various processes, all of which include long spans of a relatively narrow web. The films are handled by way of winding the films into rolls. As used herein, the reference to “machine direction” or “longitudinal direction” is along the relatively long web path of this type of production process. The reference to “transverse direction” or “cross direction” is perpendicular to the machine direction along the relatively short web width.

A number of standard test procedures are referenced herein to characterize the disclosed films and comparative materials. These test methods are included in this disclosure by reference: ASTM D1922-09 “Standard Test Method for Propagation Tear Resistance of Plastic Film and Thin Sheeting by Pendulum Method” describes the Elmendorf tear testing; ASTM D1238-10 “Standard Test Method for Melt Flow Rates of Thermoplastics by Extrusion Plastometer” describes measurement of melt index or melt flow rate; ASTM D2732-03 “Standard Test Method for Unrestrained Linear Thermal Shrinkage of Plastic Film and Sheeting” describes the measurement of free shrink; ASTM D1003-07 “Standard Test Method for Haze and Luminous Transmittance of Transparent Plastics” describes the procedure used to measure haze; ASTM F904 “Standard Test Method for Comparison of Bond Strength or Ply Adhesion of Similar Laminates Made from Flexible Materials” describes the procedure for measuring laminate bond strength; and ASTM D7192 “Standard Test Method for High Speed Puncture Properties of Plastic Films Using Load and Displacement Sensors” describes the procedure for measuring peak load impact strength and related properties.

### Multilayer Films

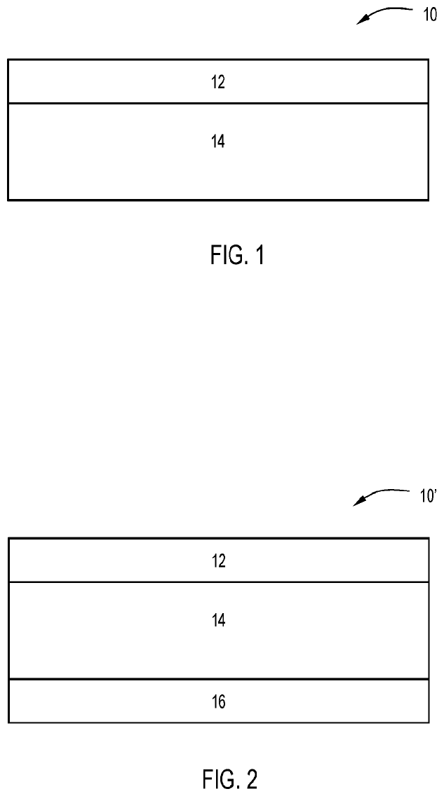

FIG. 1 shows a cross-sectional view of an embodiment of a multilayer film 10. The multilayer film 10 has a first surface layer 12 and a tear layer 14. FIG. 2 shows another embodiment of a multilayer film 10′, now including a second surface layer 16.

As described, the first and second surface layers 12,16 are located at opposite major surfaces of the multilayer film. The first and second surface layers may have the same composition or different composition. Each of the first and second surface layers contain either a polyethylene polymer or a polypropylene polymer. In some embodiments, the first and/or second surface layer comprise a polyethylene having a density greater than 0.926 g/cm³ (i.e., MDPE or HDPE). In some embodiments the first and/or second surface layer consists of a polyethylene having a density greater than 0.926 g/cm³. In some embodiments, the first and/or second surface layer comprise a polypropylene homopolymer. In some embodiments, the first and/or second surface layer consist of a polypropylene homopolymer.

Each of the first and/or second surface layer may have a thickness in a range of from 0.05 mil (1.25 micron) to 0.40 mil (10.2 micron) or from 0.10 mil (2.5 micron) to 0.40 mil (10.2 micron). Each of the first and/or second surface layer may have a thickness in a range of from 5% to 20% of the total thickness of the multilayer film. The tear layer may have a thickness in a range of from 0.4 mil (10.2 micron) to 2.8 mil (71.1 micron) or from 0.8 mil (20.3 micron) to 2.8 mil (71.1 micron). The tear layer may have a thickness in a range of from 60% to 90% of the total thickness of the multilayer film.

As shown in FIG. 2, if there is a second surface layer, the tear layer is located between the first surface layer and the second surface layer. Each of the first surface layer, the tear layer and the second surface layer (if present) are coextensive with the multilayer film. The tear layer is a polymeric blend including in a range of from 70% to 95%, by weight, of a continuous phase including a polyethylene polymer and in a range of from 5% to 30%, by weight, of a dispersed phase olefinic polymer. The tear layer may consist of the continuous phase polyethylene polymer and the dispersed phase olefinic polymer.

The polyethylene polymer of the continuous phase polymer may be a medium density polyethylene (MDPE), such as a linear medium density polyethylene (LMDPE). In some embodiments of the multilayer film, the continuous phase polymer may be a polyethylene having a melt flow index less than or equal to 3.0 g/10 min or less than or equal to 1.0 g/10 min, according to ASTMD1238 measured using 190° C./2.16 kg.

The dispersed phase olefinic polymer may be polybutylene, polypropylene, cyclic olefin copolymer, EVOH or ionomer. The dispersed phase olefinic copolymer should be selected such that it is slightly immiscible with the continuous phase polymer. If small, dispersed portions do not form upon melt blending and the tear layer is a homogenous blend, a less compatible combination should be selected. If the haze level of the multilayer film is too high upon orientation, cavitation may be occurring and a more compatible combination should be selected. For example, if the dispersed phase olefinic polymer being used is a cyclic olefin copolymer, the miscibility of the blend may be adjusted by selecting a polymer with a glass transition temperature that is closer to that of the continuous phase, for better miscibility, or further from that of the continuous phase, for less miscibility. In another example, an EVOH with a higher ethylene content would likely be more miscible with the continuous phase.

Some embodiments of the multilayer film may include additional layers. For example, the multilayer film may contain a thin oxygen barrier layer including a barrier polymer such as EVOH or polyamide. The multilayer film may include other functional layers such as tie layers or moisture barrier layers. Additional layers, especially non-olefin polymer containing layers, should be minimized such that they do not disrupt the tear performance and/or recyclability of the film.

Ideally, the multilayer film is produced by coextrusion with all of the layers simultaneously combined. Alternatively, the layers of the multilayer film may be combined by other known processes including, but not limited to, extrusion coating, extrusion lamination, and adhesive lamination. Each of the layers of the multilayer film should be combined prior to orientation of the multilayer film. In other words, each of the layers should be subjected to the same orientation process, at the same time.

The multilayer films of this disclosure are machine direction oriented films. In some embodiments, the multilayer films are only oriented in the machine direction and are not oriented to any significant amount in the transverse direction. The films may be oriented by any known means and to any degree such that the elongation of the dispersed phase olefinic polymer occurs, as will be discussed. For the examples described herein, machine direction orientation levels in a range from 2× to 8× may be suitable. In some embodiments, machine direction orientation from 3× to 6× may be suitable. In addition to orientation, the multilayer film should be annealed such that the film has a free shrink value of less than 10% in both the machine direction and the transverse direction when tested according to ASTM D2732 using bath temperature of 90° C. The multilayer film may have a free shrink less than 9%, less than 8%, less than 7%, less than 6%, less than 5%, less than 4%, less than 3%, less than 2% or less than 1% in both the machine direction and the transverse direction when tested according to ASTM D2732 using bath temperature of 90° C. The multilayer film may have a final total thickness (after orientation) in a range of 0.75 mil (19.1 micron) to 3.5 mil (88.9 micron), or from 1 mil (25.4 micron) to 3 mil (76.2 micron).

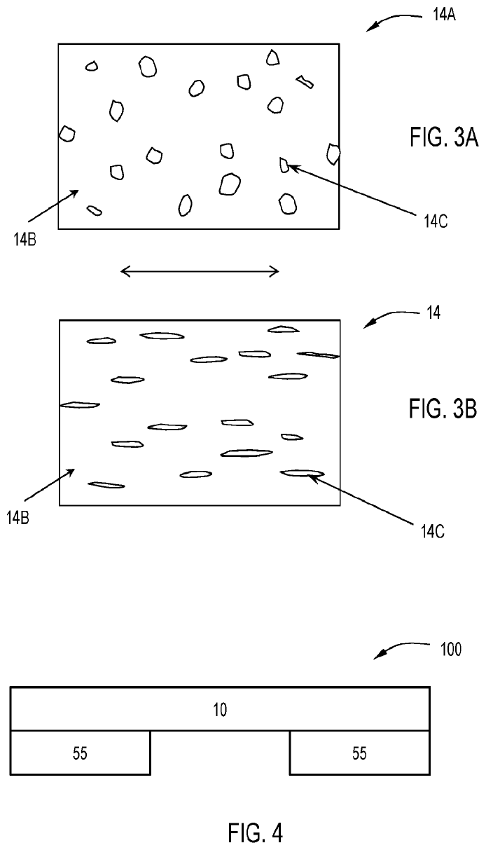

Advantageously, upon orientation, the blend of the tear layer transforms as shown in FIG. 3A, which shows a cross section of an embodiment of the tear layer before orientation 14A and FIG. 3B, which shows a cross section of an embodiment of the tear layer after orientation 14, as may be found in embodiments of the multilayer film. For reference, the machine direction is shown by the double headed arrow between these two figures. Before orientation, the tear layer 14A has continuous phase 14B and dispersed phase 14C. After orientation along the machine direction, the tear layer 14 has continuous phase 14B and dispersed phase 14C. Of note is the elongation of the dispersed phase in the machine direction. This deformation of the dispersed phase is critical to the improvement to the tear properties.

Without being limited to the theories put forth, the inventors believe that the composition and orientation of the tear layer have a few different effects on the tear propagation. First, the tear becomes easier as the propagation may tend to follow more easily along interfaces between the phases. The slight immiscibility of these phases means that they may more easily separate upon applied force such as tearing. The orientation puts some of the dispersed portions in closer proximity to each other and elongates the phase interfaces in the machine direction, both of these having the effect of lowering the overall force needed for tear propagation. Additionally, the elongation of the dispersed phase has a directional influence, specifically increasing the propensity for the propagation to travel in the machine direction as well as decreasing the propensity for the propagation to travel in the transverse direction. It is noted that the dispersed phase blend does not influence the tear properties in an unoriented film.

Additionally, it was surprisingly found that by adding the dispersed phase to the tear layer and orienting the film, a significant increase in haze was avoided. Typically, dispersed “contaminate” type additions to oriented layers will cause increases in haze due to even small amounts of cavitation or separation of the dispersed phase and the continuous phase.

The multilayer film has a haze level less than 15% when measured according to ASTM D1003. Some embodiments of the multilayer film have a haze level less than 14%, less than 12%, less than 10%, less than 8% or less than 6%. This multilayer film may have a much lower haze level than other polyethylene rich machine direction oriented films that are designed for MD tear.

Due to the design of the film structure and layer composition as described herein, the multilayer films have excellent machine direction tear properties. A multilayer film, upon initiating the tear with a notch, has extremely easy and clean tear propagation in the machine direction. The tear resistance is very low in the machine direction and very high in the transverse direction. A ratio of the measured Elmendorf tear value in the transverse direction to the measured Elmendorf tear value in the machine direction is greater than 10, greater than 20, greater than 30, greater than 40, or greater than 50.

### Laminates

The multilayer films described herein, having excellent machine direction tear properties and low haze, are useful in many applications including laminate films that are used for packaging. In some cases, the multilayer film will have a sealing layer as part of its structure (i.e., the second surface layer is sealable). In this case, the multilayer film including a sealing layer is considered a “laminate” and may be used to form packages. In other embodiments, a sealing layer and/or other additional layers may be added to the multilayer film to form a laminate film.

As noted above, an oxygen or moisture barrier layer may be part of the multilayer film. In further embodiments, a barrier layer may be added to another part of a laminate film that includes the multilayer film. For example, a coating may be deposited on a surface of the multilayer film, such as a vacuum deposited layer of SiOx or a solution coated layer of EVOH. In other embodiments, a sealing film as will be described, containing a barrier layer may be laminated to the multilayer film.

In some embodiments of the laminate films including the multilayer film, an exposed surface of the multilayer film (i.e., the first surface layer) is covered by a heat-resistant over-print varnish or lacquer. The over-print varnish may cover the entire exposed surface of the multilayer film or it may be patterned. Preferably, this layer of varnish is clear and very thin, adding almost no additional stiffness to the overall structure. Additionally, the laminate film may include printed indicia located on the either or both surfaces of the multilayer film, providing graphics to the overall film and package.

A sealing layer added to the laminate film may have a composition that will allow the formation of a heat seal, thus forming a hermetically-sealed package. As used herein, the term “heat seal”, “heat sealable” or “heat sealed” refers to two or more surfaces that have been or can be bonded together by application of both heat and pressure. Heat sealing is a well-known and commonly used process for creating packages and is familiar to those skilled in the art. Without intending to be bound by theory, during heat sealing, the sealing layer softens due to the application of heat, allowing formation of a heat seal bond. Since the heat must be driven through the entire laminate film to raise the temperature of the sealable material, it is advantageous if the heat sealing layer softens and seals at a relatively low temperature. Lower seal initiation temperature (SIT) enables faster packaging line speeds. For example, some embodiments of the laminate film may include a sealing layer that exhibits an SIT of less than or equal to 110° C., less than or equal to 100° C., or less than or equal to 90° C.

The laminate film may include a patterned sealing layer as a surface layer. As used herein, the term “patterned” means that the layer of sealable material is discontinuous with the multilayer film. The sealing layer is discontinuous with the multilayer film upon which it is applied. The patterned sealing layer may be applied to areas of the laminate film that are involved with closing the package by sealing. The sealing layer may be applied over greater than or equal to 5%, greater than or equal to 10%, or greater than or equal to 15% of the surface of the multilayer film. The sealing layer may be applied over less than or equal to 30%, less than or equal to 25%, or less than or equal to 20% of the multilayer film.

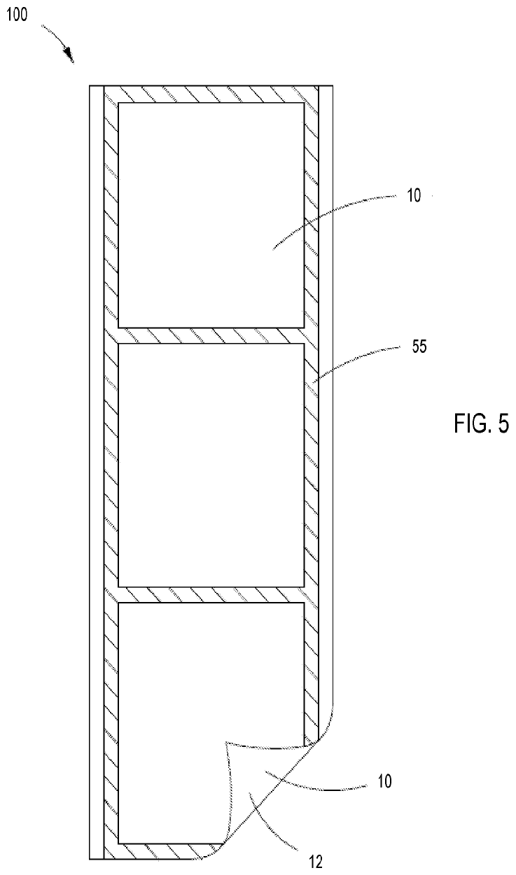

An embodiment of a laminate film 100 that includes a patterned sealing layer 55 is shown in FIGS. 4 and 5. FIG. 4 is a cross sectional view of the laminate film 100 including the multilayer film 10 and the sealing layer 55. As shown, the sealing layer 55 is discontinuous with the laminate (i.e., discontinuous with the multilayer film). FIG. 5 is a plan view of the laminate, showing the surface including the sealing layer 55 (hashmark area). Also visible on this surface are the areas of the multilayer film 10 that have not been covered by the sealing layer 55. A corner of the laminate film 100 has been turned up to show that the opposite surface of the laminate film 100 includes the multilayer film 10 and specifically, the first surface layer 12 of the multilayer film 10.

Possible heat sealable materials used in sealing layers may include, but are not limited to, acrylate copolymers, PET, PE, PP, or hot melts (wax based). These may be applied as a thin coating, either over the entire surface of the laminate or in a pattern.

A patterned sealing layer may alternatively be comprised of a pressure sensitive cold seal material. This embodiment of the laminate film is advantageous as formation of the package does not require heat. Without intending to be bound by theory, the pressure sensitive cold seal may be advantageous for the packaging of heat sensitive products such as ice cream or chocolates. Embodiments of the laminate film may include a pressure sensitive cold seal system including, but not limited to, natural or synthetic polyisoprene latex, or styrene-butadiene copolymer latex. The cold seal material may comprise blends that include acrylates and/or tackifiers.

A patterned sealing layer may be applied at a thickness that allows for hermetic sealing, even in challenging applications such as triple point region sealing. In some embodiments, the patterned sealing layer may be applied at a basis weight of greater than or equal to 1 g/m² or greater than or equal to 3 g/m². In other embodiments, the sealing layer may be applied at a basis weight of less than or equal to 8 g/m², less than or equal to 9 g/m², or less than or equal to 10 g/m². For example, the sealing layer may have a basis weight in a range of from about 1 g/m² to about 10 g/m², or in a range of from about 3 g/m² to about 9 g/m².

A continuous sealing layer may be applied to the multilayer film at a thickness that allows for hermetic sealing. In some embodiments, the continuous sealing layer may be applied at a basis weight of greater than or equal to 1 g/m² or greater than or equal to 3 g/m². In other embodiments, the sealing layer may be applied at a basis weight of less than or equal to 8 g/m², less than or equal to 9 g/m², or less than or equal to 10 g/m². For example, the sealing layer may have a basis weight in a range of from about 1 g/m² to about 10 g/m², or in a range of from about 3 g/m² to about 9 g/m².

As used herein, the term “basis weight” is used to refer to the amount of material by weight that is present in a predetermined area of a film or layer. Typically, the area defined is a square meter, but any area can be used. The area is defined in the length-width (i.e., x-y direction) of the film or layer. A material of a given thickness (z-direction) and density, has a specific weight when covering a defined area (i.e., a square meter). Materials that are applied in discontinuous layers, such as a patterned sealing layer, can be defined by basis weight. In the case of patterns, the basis weight refers to the amount of material by weight that is present when covering a defined area.

A thin seal layer, such as a heat seal lacquer or patterned cold seal, applied directly to the multilayer film, or with only a primer intervening, is highly advantageous as it often does not become overly detrimental to the tear properties of the multilayer film. Laminate films consisting of a multilayer film, a sealing layer and optionally printed indicia and overlacquer, will retain nearly the full advantages of the multilayer film, including excellent tear properties and very low haze. In some embodiments, the laminate consists of a multilayer film and a sealing layer. In some embodiments, the laminate consists of a multilayer film, printed graphics (indicia) and a sealing layer.

A sealing layer may be added to the multilayer film to form a laminate film by way of adhesive lamination of a sealing film. FIG. 7 shows a cross-section of an embodiment of a laminate film 100′ including a multilayer film 10, a sealing film 50 and an adhesive layer 30 therebetween. The sealing film 50 includes a sealing layer 55. The sealing film 50 may be monolayer, in which case the sealing film 50 consists of the sealing layer 55). The sealing film 50 may be multilayer, including a sealing layer 55 located at the exposed surface of the laminate. The sealing film may be a coextruded blown film, including a sealing layer, a laminating layer (i.e., the layer attached to the adhesive layer) and optionally one or more barrier layers and/or tie layers.

A sealing film may have a thickness of from 1 mil (25.4 micron) to 4 mil (101.6 micron), or from 1 mil (25.4 micron) to 3 mil (76.2 micron). A sealing film may be produced by a blown film or cast film process. The sealing film may be oriented or unoriented, although the sealing functionality generally benefits from a lack of orientation. The sealing film should have a normalized peak load impact strength of less than 0.5 N/micron

The adhesive layer of the laminate plays an important role in optimizing the tear properties of the laminate. The adhesive layer may include any typical type of adhesive used for film lamination, including those utilizing water-based chemistry, solvent-based chemistry, energy curing or solventless chemistry. The critical factor is to obtain a strong bond to both the multilayer film and the sealing film. A strong bond ensures that the tear strength of the laminate remains low. The bond achieved by the adhesive layer should be greater than 200 g/in, greater than 300 g/in or greater than 500 g/in. Lower bond strength causes webbing, poor tear quality and high tear strength of the laminate.

The sealing film should be designed to comply with the overall goal of achieving excellent machine direction tear. A good predictor of easy tear properties is a low puncture strength. The sealing film may have a normalized peak load impact strength less than 0.5 N/micron, less than 0.4 N/micron or less than 0.3 N/micron. Overall, it is advantageous if the laminate has a normalized peak load impact strength less than 30 N/mil (1.18 N/micron), less than 20 N/mil (0.79 N/micron), less than 15 N/mil (0.59 N/micron) or less than 10 N/mil (0.39 N/micron), measured according to ASTM D7192. The laminate should have a normalized peak load impact strength of greater than 2 N/mil (0.08 N/micron), greater than 5 N/mil (0.20 N/micron), or greater than 10 N/mil (0.39 N/micron).

Due to the design of the laminate film structure and inclusion of the multilayer film as described herein, the laminate films have excellent machine direction tear properties. A laminate film, upon initiating the tear with a notch, has extremely easy and clean tear propagation in the machine direction. The tear resistance is very low in the machine direction and very high in the transverse direction. The machine direction Elmendorf tear value may be in a range from 1 g to 100 g, in a range from 2 g to 50 g, in a range from 5 g to 25 g or in a range from 5 g to 15 g. A ratio of the measured Elmendorf tear value in the transverse direction to the measured Elmendorf tear value in the machine direction is greater than 2, greater than 3, greater than 4, or greater than 5.

A line of weakness or “weakening line” may be present in one or more layers/films of a laminate film. In some embodiments, a weakening line is formed mechanically. In other embodiments, a weakening line may be formed by laser scoring (i.e., a laser scored line of weakness). A weakening line may be non-continuous (i.e., a perforation) or continuous. A weakening line may be formed either partially or fully in one or more layers of the multilayer film or the sealing film. In some embodiments, there are multiple weakening lines in a single laminate film, running parallel to each other. A particularly advantageous embodiment may include a weakening line through either a portion of or the entirety of the sealing film, and the multilayer film does not include a weakening line. A weakening line may fully or partially guide a tear in the machine direction and may or may not lower the tear resistance. In some embodiments, the laminate may be free of a weakening line.

### Packaged Products

Advantageously, the laminate films discussed herein may be used as packaging film for packaged products. The packaged products may include one or more embodiments of the laminate films, plus other components such as trays, cups, zippers, fitments and other types of films. The packaging portion of the packaged product may be formed by sealing. The sealing layer of the laminate films is attached to another surface, such as itself or another sealing layer of another component, by a sealing process. The sealing process may be, but is not limited to heat sealing, ultrasonic sealing or cold sealing. Ideally, the sealing is completed in such a way that the package is hermetically sealed and the product therein is protected from the environment.

In some embodiments, the sealing layer of the laminate film acts as a caulking agent. In some embodiments, the sealing layer flows into a gap of a triple point region (described below) at the sealing conditions. Without intending to be bound by theory, the ability to properly seal the triple-point may result from a combination of material properties, coating weight and sealing conditions. It is believed that having a sealing layer that is relatively thick in the areas of the heat seals greatly increases the potential to reduce the size of the triple point region of the seal. In one or more preferred embodiments, the sealing layer is not oriented.

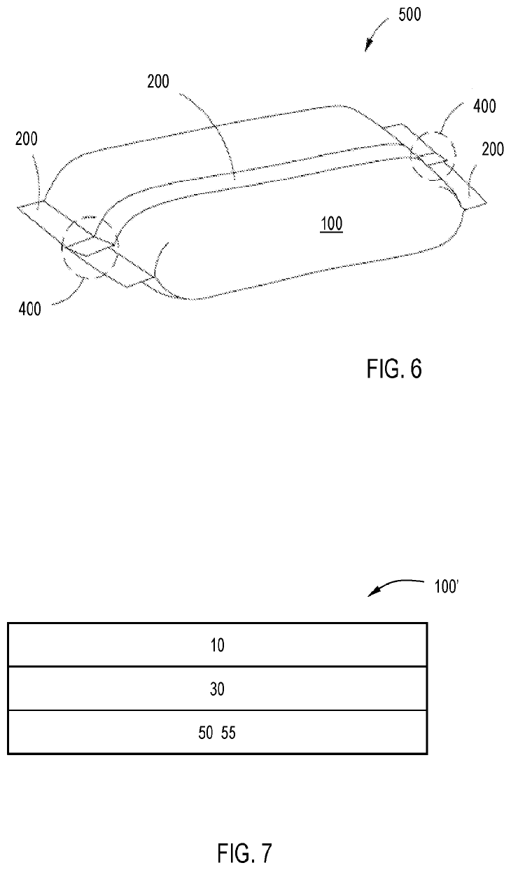

An embodiment of a packaged product 500 that is formed using a laminate film 100 is shown in FIG. 6. The style of the packaged product 500 is a standard flow wrap wherein the laminate film 100 is folded around the product (not shown) in a tube shape and a fin seal 200 is formed down the length of the package, in the machine direction of the laminate film 100, and transversely oriented seals 200 form the ends of the package. A triple point seal 400 is formed at the intersections of the fin seal and the end seals. The sealing layer of the laminate film 100 is facing the inside of the package (i.e., in contact with the product therein) and the multilayer film of the laminate film 100 is facing the outside of the package (i.e., exposed to the environment). This style of package may advantageously be made with a patterned sealing layer, but any type of laminate film may be used.

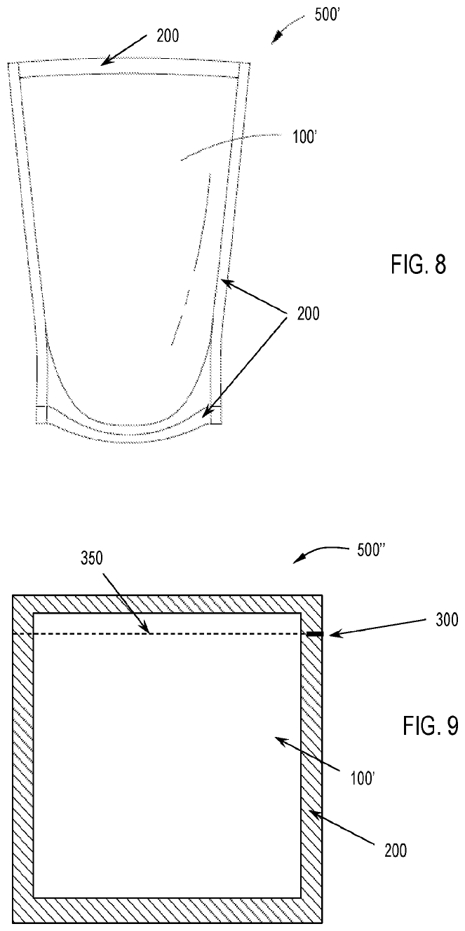

Another embodiment of a packaged product 500′ that may be formed using a laminate film 100′ includes a stand-up pouch as shown in FIG. 8. Herein, the laminate is folded and sealed (see seals 200), including the bottom gusset, having the machine direction of the laminate film 100′ across the pouch, from left-to-right as shown in the figure. The pouch is then filled with a product (not shown) and an additional seal 200 is formed across the top. In this way, the pouch may benefit from the laminate film as the top of the pouch may be cleanly torn away, offering easy opening.

As previously discussed, a laminate film may include a weakening line. A weakening line may be present in one or more laminates of a packaged product. A weakening line may be either continuous, spanning from one side edge of a pouch or package to the other side edge of the pouch or package, or it may be intermittent. In some embodiments, there are multiple weakening lines in a single laminate film, running parallel to each other. A particularly advantageous embodiment of a packaged product 500″ in the form of a pouch or sachet is shown in FIG. 9. Here, the packaged product 500″ includes a weakening line 350 in the laminate film 100′ that forms the front panel and a weakening line in the laminate film that forms the back panel (not shown). Each of the weakening lines span across the front or back panel. In some embodiments, the packaged product may be free from laminates that include weakening lines.

The packaged product 500″ further includes a tear initiator 300. As used herein, a “tear initiator” is a feature which aids in the initiation of manual tearing of a film. Examples of tear initiators may be cuts or notches (i.e. area where a small portion of the film has been removed) within the seal area 200 of a sealed package 500″. In some embodiments, a weakening line may act as a tear initiator. Ideally, a tear initiator 300 is aligned with or closely aligned with a weaking line 350. Some embodiments of packaged products include one or both of tear initiators and weakening lines.

A packaged product including the laminate films as described herein may benefit from superior tear opening performance. Tearing the package in a direction that follows the machine direction of the laminate(s) will result in a low effort tear (low tear strength), straight tear and clean tear without stretching of the laminate film. The packaged product may benefit from these superior tear properties without the use of a weakening line. The packaged product will also benefit from a low haze laminate, allowing a better appearance to the overall package and product.

### EXAMPLES & DATA

Multilayer films 1, 2, 3, 4, 5, 6, 7 and 8 were produced by a blown film coextrusion process and have a composition and structure as shown below. In all examples of film given herein, %'s are by weight unless otherwise noted, slashes (/) show layer interfaces and materials within parenthesis are physical blends wherein the minor component is present as a dispersed phase. Multilayer films 1 through 8 are not oriented and thus not representative of the inventive multilayer films described herein and are included for comparative purposes.

Multilayer film 1 had a 5.5 mil (139.7 micron) total thickness and a structure of [15% HDPE/70% (85% mLMDPE+15% PP copolymer)/15% HDPE]. Multilayer film 1 had a total composition including 100% polyolefin and 89.5% polyethylene, by weight.

Multilayer film 2 had a 5.5 mil total thickness and a structure of [15% HDPE/70% (85% mLMDPE+15% PP homopolymer)/15% HDPE]. Multilayer film 2 had a total composition including 100% polyolefin and 89.5% polyethylene, by weight.

Multilayer film 3 had a 5.5 mil total thickness and a structure of [15% HDPE/70% (95% mLMDPE+5% PB copolymer)/15% HDPE]. Multilayer film Multilayer film 3 had a total composition including 100% polyolefin and 89.5% polyethylene by weight.

Multilayer film 4 had a 5.5 mil total thickness and a structure of [15% HDPE/70% (85% mLMDPE+15% PB copolymer)/15% HDPE]. Multilayer film 4 had a total composition including 100% polyolefin and 89.5% polyethylene, by weight.

Multilayer film 5 had a 5.5 mil total thickness and a structure of [15% HDPE/70% (85% mLMDPE+15% PB homopolymer)/15% HDPE]. Multilayer film 5 had a total composition including 100% polyolefin and 89.5% polyethylene, by weight.

Multilayer film 6 had a 5.5 mil total thickness and a structure of [15% HDPE/70% (95% mLMDPE+5% COC1)/15% HDPE]. Multilayer film 6 had a total composition including 100% polyolefin and 100% polyethylene, by weight.

Multilayer film 7 had a 5.5 mil total thickness and a structure of [15% HDPE/70% (95% mLMDPE+5% COC2)/15% HDPE]. Multilayer film 6 had a total composition including 100% polyolefin and 100% polyethylene, by weight.

Multilayer film 8 had a 5.5 mil total thickness and a structure of [15% HDPE/70% mLMDPE/15% HDPE]. Multilayer film 6 had a total composition including 100% polyolefin and 100% polyethylene, by weight.

In multilayer films 1 through 8, the HDPE used had a density of 0.958 g/cm³ and melt index 0.45 g/10 min (190° C./2.16 kg), the mLMDPE used had a density of 0.935 g/cm³ and melt index 0.50 g/10 min (190° C./2.16 kg), the PP copolymer was a random copolymer having a density of 0.90 g/cm³ and melt index 8.0 g/10 min (190° C./2.16 kg), the PP homopolymer was a nucleated polymer having a melt index 2 g/10 min (230° C./2.16 kg), PB copolymer was a random copolymer of butene-1 and ethylene having a density of 0.906 g/cm³ and melt index 1 g/10 min (190° C./2.16 kg), PB homopolymer was a semi-crystalline polymer having a density of 0.914 g/cm³ and melt index 0.4 g/10 min (190° C./2.16 kg), COC1 was a cyclic olefin copolymer having a density of 1.02 g/cm³ and glass transition temperature 78° C., and COC2 was a cyclic olefin copolymer having a density of 1.02 g/cm³ and glass transition temperature 140° C. These polymer designations are used throughout the other examples as well.

Multilayer films 1 through 7 were further processed by off-line machine direction orientation thus producing corresponding multilayer films 1A through 7A that are representative of the inventive multilayer films described herein. The films were oriented 5.5×, resulting in films having a thickness of approximately 1.0 mil (25.4 micron).

Additionally, multilayer film 8 was similarly machine direction oriented. However, corresponding film 8A does not include the dispersed phase within the interior layer. Thus, multilayer film 8A is not representative of the inventive multilayer films and is included for comparative purposes.

The tear properties for multilayer films 1 through 8 and 1A through 8A are shown in Table 1. Tear properties were measured according to ASTM D1922. The data collected include Elmendorf tear values in both the machine direction (MD) and transverse direction (TD). For each film and tear direction, ten data points were collected and the average Elmendorf tear value is shown in Table 1. The calculated tear ratio is also given in Table 1, calculated using the average values (average TD tear/average MD tear). Also shown in Table 1 is the pendulum weight used for the testing.

TABLE 1
Elmendorf Tear Values measured according to
ASTM D1922, and Calculated Tear Ratio (TD/MD)

| | Machine Direction (MD) | | Transverse Direction (TD) | | |
|---|---|---|---|---|---|
| Multilayer | Pendulum | Elmendorf | Pendulum | Elmendorf | Ratio |
| Film | Weight (g) | Tear Value (g) | Weight (g) | Tear Value (g) | (TD/MD) |
| 1 | 800 | 321 | 800 | 563 | 1.8 |
| 2 | 800 | 257 | 800 | 440 | 1.7 |
| 3 | 800 | 392 | 800 | 710 | 1.8 |
| 4 | 800 | 435 | 800 | 740 | 1.7 |
| 5 | 800 | 409 | 800 | 771 | 1.9 |
| 6 | 800 | 359 | 800 | 588 | 1.6 |
| 7 | 800 | 400 | 800 | 606 | 1.5 |
| 8 | 800 | 384 | 800 | 634 | 1.6 |
| 1A | 200 | 10.2 | 800 | 260 | 25.6 |
| 2A | 200 | 13.4 | 800 | 170 | 12.7 |
| 3A | 200 | 5.0 | 800 | 288 | 57.1 |
| 4A | 200 | 5.6 | 800 | 290 | 52.2 |
| 5A | 200 | 9.0 | 800 | 273 | 30.2 |
| 6A | 200 | 5.6 | 800 | 240 | 42.9 |
| 7A | 200 | 6.6 | 800 | 427 | 64.8 |
| 8A | 200 | 92 | 800 | 394 | 4.3 |

While the multilayer films 1 through 8 are not oriented, it is observed that the addition of the dispersed phase to the core layer as in multilayer films 1 through 7 does not significantly decrease the tear resistance of the films. Comparing to multilayer film 8, which does not have a dispersed phase olefinic polymer, the tear values are nearly the same. Additionally, all of the multilayer films 1 through 8 have a tear value ratio (TD/MD) from 1.5 to 1.9. The added dispersed phase does not increase the ratio of the tear value in the transverse direction to the tear value in the machine direction. In other words, the added dispersed phase olefinic polymer does not increase the propensity of the film to tear in the machine direction as opposed to the transverse direction when compared to a film that does not contain a dispersed phase olefinic polymer.

After machine direction orientation was introduced, each of the multilayer films 1A through 8A demonstrate lower tear resistance in both the transverse direction and the machine direction. This is generally attributable to the decreased thickness of the films as compared to the unoriented films 1 through 8. However, the machine direction orientation had a bigger effect on the machine direction tear resistance. Analysis of the tear ratio (TD/MD) of multilayer film 8A (4.3) shows the base increase due to the machine direction orientation. The influence of the dispersed phase olefin polymer on the tear ratio is stark, increasing to a range of 12.7 to 64.8.

The haze of the oriented multilayer films 1A through 8A was also measured, according to ASTM D1003, and results are shown in Table 2. These results show that the addition of the dispersed phase olefin polymer and subsequent machine direction orientation is not causing voiding greater than 200 nm within the tear layer. It should be noted that multilayer film 7A, containing a COC with relatively high T_{g} is beginning to show increased haze suggesting that there is some cavitation occurring. This indicates that this is on the edge of the intent of the currently disclosed multilayer films. The current disclosure includes using a dispersed phase olefin polymer in the tear layer, that dispersed phase olefin polymer being dissimilar enough to create a dispersion, but not so dissimilar to separate from the main component under the stress of orientation. Likely, the COC of multilayer film 7A did not soften during the orientation process, thus not flowing with the main component and creating some slight cavitation and haze. The current films disclosed herein have an intent to increase the tear ratio while not changing the haze level significantly.

TABLE 2
Haze Values measured according to ASTM D1003

| Multilayer Film | Haze (%) |
|---|---|
| 1A | 12.6 |
| 2A | 11.5 |
| 3A | 13.0 |
| 4A | 11.9 |
| 5A | 12.7 |
| 6A | 10.9 |
| 7A | 21 |
| 8A | 10.9 |

Several laminates (laminates A, B, C, D, E, F and G) were produced to analyze the tear performance of the inventive films. Each laminate was produced by using an adhesive laminating process, bonding an MDO film to a sealing film, the final structure of the films given below. Laminates A, B, C and E are comparative and laminates D, F and G are according to the inventive laminates described herein.

Laminate A had a 1 mil MDOPE film laminated to a 2.5 mil white sealing film. The MDOPE film had a structure of 10% HDPE/10% (HDPE+mLMDPE)/60% mLMDPE/10% (HDPE+mLMDPE)/10% HDPE. The adhesive was applied at approximately 1.3 lb/rm dry weight and was a solvent based epoxy amine type. The sealing film was a 2.5 mil blown film having the structure of 29% LLDPE/42% (HDPE+white concentrate)/29% mLLDPE.

Laminate B had a similar structure as laminate A, having the same MDOPE film and the same sealing film. The adhesive was applied at approximately 1.7 lb/rm dry weight and was a water based adhesive.

Laminate C also had a similar structure as laminate B. The MDOPE was a 0.9 mil MDO HDPE film. The sealing film and the adhesive was the same as used in laminate B.

Laminate D had a 1 mil MDO film (5:1 stretch) having the structure 15% HDPE/70% (90% mLMDPE+10% PB copolymer)/15% HDPE.

Laminate D used the same adhesive and sealing film as laminate B. Laminate D had a total composition including 96.8% polyolefin and 95% polyethylene, by weight.

Laminate E used the same MDO film as laminate D. The laminate was made using about 1 lb/rm of a solventless adhesive. The sealing film was a 2.5 mil blown film having the structure of 19% LLDPE/62% (LLDPE+white concentrate)/19% LLDPE.

Laminate F used the same MDO film and adhesive as laminate E and the same sealing film as laminate A. Laminate F had a total composition including 98.1% polyolefin and 96.2% polyethylene, by weight.

Tear data was collected for the laminate films in the same manner as the multilayer laminates. Laminate tear data is shown in Table 3.

TABLE 3
Elmendorf Tear Values measured according to
ASTM D1922, and Calculated Tear Ratio (TD/MD)

| | Machine Direction (MD) | | Transverse Direction (TD) | | |
|---|---|---|---|---|---|
| | Pendulum | Elmendorf | Pendulum | Elmendorf | Ratio |
| Laminate | Weight (g) | Tear Value (g) | Weight (g) | Tear Value (g) | (TD/MD) |
| A | 800 | 357 | 800 | 335 | 0.9 |
| B | 800 | 160 | 800 | 290 | 2.1 |
| D | 200 | 62.1 | 400 | 252 | 4.2 |
| E | 6400 | 2435 | 800 | 476 | 0.2 |
| F | 200 | 127 | 800 | 294 | 2.4 |

The Peak Load Impact Strength was measured on laminates B, C and D. The data was collected according to ASTM D7192. Note that ASTM D7192 is for films that have a thickness less than 10 mil while ASTM D3763 is meant for films that have a thickness greater than 10 mil, although the tests are essentially the same. The data was collected using a 0.25 inch probe with the probe directed to the MDO film side of each laminate. The results reported in Table 4 are the average value of five samples of each laminate sample. The thickness of the film used to calculate the peak load was determined by ten measurements on each laminate sample.

TABLE 4
Peak Load Impact Strength measured according
to ASTM D7192, and Normalized Peak Load

| | | | | Normalized | |
|---|---|---|---|---|---|
| Laminate | Peak | Total | Total | Peak Load | |
| (average | Load | Deformation | Energy | (lb/mil) | |
| thickness) | (lbs) | (in) | (ft-lbs) | (N/micron) | |
| B (3.94 mil) | 12.1 | 1.03 | 0.62 | 3.08 | 0.54 |
| C (3.47 mil) | 11.6 | 0.45 | 0.23 | 3.33 | 0.58 |
| D (3.69 mil) | 11.8 | 0.66 | 0.33 | 3.21 | 0.56 |

To be successful in developing an easy tear structure, one must consider all elements in a structure. Starting with an easy tear print web does not always lend itself to an easy tear structure if the sealant is too resistant to tear. Ideally, the sealing layer should have a machine direction Elmendorf tear value lower than 400 g, lower than 200 g or lower than 100 g.

### Multilayer Film Embodiments

A. A multilayer film comprising:
a first surface layer comprising polyethylene or polypropylene polymer; and
a tear layer comprising in a range of from 70% to 95%, by weight, of a continuous phase polyethylene polymer, and in a range of from 5% to 30%, by weight, of one or more of a dispersed phase olefinic polymer selected from the group of polybutylene, polypropylene, cyclic olefin copolymer, EVOH and ionomer, the tear layer having a thickness in a range of from 60% to 90% of the total thickness of the multilayer film; and
wherein the multilayer film is oriented in the machine direction; and a ratio of a transverse direction Elmendorf tear strength of the multilayer film to a machine direction Elmendorf tear strength of the multilayer film is greater than 10, Elmendorf tear strength measured according to ASTM D1922.
B. The multilayer film according to any other multilayer film embodiment wherein the first surface layer comprises a polyethylene having a density in a range of from 0.918 g/cm³ to 0.970 g/cm³ or a polypropylene homopolymer.
C. The multilayer film according to any other multilayer film embodiment further comprising a second surface layer comprising polyethylene or polypropylene polymer.
D. The multilayer film according to Embodiment C wherein the second surface layer comprises a polyethylene having a density in a range of from 0.918 g/cm³ to 0.970 g/cm³ or a polypropylene homopolymer.
E. The multilayer film according to any other multilayer film embodiment wherein the continuous phase polyethylene polymer is a medium-density polyethylene.
F. The multilayer film according to any other multilayer film embodiment wherein the continuous phase polyethylene polymer has a melt flow index less than or equal to 3.0 g/10 min, according to ASTMD1238 (190° C./2.16 kg).
G. The multilayer film according to any other multilayer film embodiment further comprising a free shrink value of less than 10% in both the machine direction and the transverse direction when tested according to ASTM D2732 using bath temperature of 90° C.
H. The multilayer film according to any other multilayer film embodiment wherein the ratio of the transverse direction Elmendorf tear to the machine direction Elmendorf tear is greater than 20.
I. The multilayer film according to any other multilayer film embodiment wherein the haze is less than 15% when measured according to ASTM D1003.
J. The multilayer film according to any other multilayer film embodiment further comprising a total composition comprising a polyolefin content in a range of from 95% to 100%, by weight.
K. The multilayer film according to any other multilayer film embodiment further comprising a total composition comprising a polyethylene content in a range of from 85% to 100%, by weight.
L. A multilayer film comprising:
a total thickness in a range of from 0.75 mil (19.1 micron) to 3.5 mil (88.9 micron); a first surface layer comprising a high-density polyethylene, the first surface layer having a thickness in a range from 5% to 20%, by volume, of the total thickness;
a second surface layer comprising a high-density polyethylene, the second surface layer having a thickness in a range of from 5% to 20%, by volume, of the total thickness; and
a tear layer located between the first surface layer and the second surface layer, the tear layer comprising in a range of from 70% to 95%, by weight, of a continuous phase medium-density polyethylene or a continuous phase high-density polyethylene, and in a range of from 5% to 30%, by weight, of one or more of a dispersed phase olefinic polymer selected from the group of polybutylene, polypropylene, cyclic olefin copolymer, EVOH and ionomer; and
wherein the multilayer film is oriented in the machine direction; and
a ratio of a transverse direction Elmendorf tear strength of the multilayer film to a machine direction Elmendorf tear strength of the multilayer film is greater than 10, Elmendorf tear strength measured according to ASTM D1922.

### Laminate Film Embodiments

M. A laminate film comprising any multilayer film embodiment and a sealing layer selected from one of a heat seal coating or a cold seal blend.
N. A laminate film according to Embodiment M wherein the sealing layer is coextensive with the multilayer film.
O. A laminate film according to Embodiment M wherein the sealing layer is patterned with regard to the multilayer film.
P. A laminate film comprising:
any multilayer film embodiment;
a sealing film comprising a sealing layer; and
an adhesive layer located between the multilayer film and the sealing film.
Q. The laminate film according to Embodiment P wherein:
the adhesive layer is in direct contact with the multilayer film;
the adhesive layer is in direct contact with the sealing film; and
the bond strength when separating the multilayer film from the sealing film is greater than 200 g/in, as measured using ASTM F904.
R. The laminate film according to Embodiment P or Q wherein the sealing film has a normalized peak load impact strength of less than 0.5 N/micron, according to ASTM D7192.
S. The laminate film according to Embodiment P, Q or R further comprising a normalized peak load impact strength in a range of from 10 N/mil to 15 N/mil (0.39 N/micron to 0.59 N/micron), according to ASTM D1792.
T. The laminate film according to any other laminate film embodiment further comprising:
a machine direction Elmendorf tear value less than 150 g; and
a ratio of a transverse direction Elmendorf tear strength of the multilayer film to a machine direction Elmendorf tear strength of the multilayer film greater than 2, Elmendorf tear strength measured according to ASTM D1922.
U. The laminate film according to Embodiment P, Q, R, S or T further comprising a weakening line located in at least one of the multilayer film and the sealing film.
V. The laminate film according to any other laminate film embodiment further comprising a total composition comprising a polyolefin content in a range of from 95% to 100%, by weight.
W. The laminate film according to any other laminate film embodiment further comprising a total composition comprising a polyethylene content in a range of from 90% to 100%, by weight.

### Packaged Product Embodiment

X. A packaged product comprising any laminate film embodiment, wherein at least one seal bonding the sealing layer to itself and a tear initiation feature.

1. A multilayer film comprising:
a first surface layer comprising polyethylene or polypropylene polymer; and
a tear layer comprising in a range of from 70% to 95%, by weight, of a continuous phase polyethylene polymer, and in a range of from 5% to 30%, by weight, of one or more of a dispersed phase olefinic polymer selected from the group of polybutylene, polypropylene, cyclic olefin copolymer, EVOH and ionomer, the tear layer having a thickness in a range of from 60% to 90% of a total thickness of the multilayer film; and
wherein the multilayer film is oriented in the machine direction; and
a ratio of a transverse direction Elmendorf tear strength of the multilayer film to a machine direction Elmendorf tear strength of the multilayer film is greater than 10, Elmendorf tear strength measured according to ASTM D1922.

2. The multilayer film according to claim 1 wherein the first surface layer comprises a polyethylene having a density in a range of from 0.918 g/cm³ to 0.970 g/cm³ or a polypropylene homopolymer.

3. The multilayer film according to claim 1 further comprising a second surface layer comprising polyethylene or polypropylene polymer.

4. The multilayer film according to claim 3 wherein the second surface layer comprises a polyethylene having a density in a range of from 0.918 g/cm³ to 0.970 g/cm³ or a polypropylene homopolymer.

5. The multilayer film according to claim 1 wherein the continuous phase polyethylene polymer is a medium-density polyethylene.

6. The multilayer film according to claim 1 wherein the continuous phase polyethylene polymer has a melt flow index less than or equal to 3.0 g/10 min, according to ASTMD1238 (190° C./2.16 kg).

7. The multilayer film according to claim 1 further comprising a free shrink value of less than 10% in both the machine direction and the transverse direction when tested according to ASTM D2732 using bath temperature of 90° C.

8. The multilayer film according to claim 1 wherein the ratio of the transverse direction Elmendorf tear to the machine direction Elmendorf tear is greater than 20.

9. The multilayer film according to claim 1 wherein the haze is less than 15% when measured according to ASTM D1003.

10. The multilayer film according to claim 1 further comprising a total composition comprising a polyolefin content in a range of from 95% to 100%, by weight.

11. The multilayer film according to claim 1 further comprising a total composition comprising a polyethylene content in a range of from 85% to 100%, by weight.

12. A multilayer film comprising:
a total thickness in a range of from 0.75 mil (19.1 micron) to 3.5 mil (88.9 micron);
a first surface layer comprising a high-density polyethylene, the first surface layer having a thickness in a range of from 5% to 20% of the total thickness;
a second surface layer comprising a high-density polyethylene, the second surface layer having a thickness in a range of from 5% to 20% of the total thickness; and
a tear layer located between the first surface layer and the second surface layer, the tear layer comprising in a range of from 70% to 95%, by weight, of a continuous phase medium-density polyethylene or a continuous phase high-density polyethylene, and in a range of from 5% and 30%, by weight, of one or more of a dispersed phase olefinic polymer selected from the group of polybutylene, polypropylene, cyclic olefin copolymer, EVOH and ionomer; and
wherein the multilayer film is oriented in the machine direction; and
a ratio of a transverse direction Elmendorf tear strength of the multilayer film to a machine direction Elmendorf tear strength of the multilayer film is greater than 10, Elmendorf tear strength measured according to ASTM D1922.

13. A laminate film comprising the multilayer film according to claim 1 and a sealing layer selected from one of a heat seal coating or a cold seal blend.

14. A laminate film according to claim 13 wherein the sealing layer is coextensive with the multilayer film.

15. A laminate film according to claim 13 wherein the sealing layer is patterned with regard to the multilayer film.

16. A laminate film comprising:
the multilayer film according to claim 1;
a sealing film comprising a sealing layer; and
an adhesive layer located between the multilayer film and the sealing film.

17. The laminate film according to claim 16 wherein:
the adhesive layer is in direct contact with the multilayer film;
the adhesive layer is in direct contact with the sealing film; and
the bond strength when separating the multilayer film from the sealing film is greater than 200 g/in, as measured using ASTM F904.

18. The laminate film according to claim 16 wherein the sealing film has a normalized peak load impact strength of less than 0.5 N/micron, according to ASTM D7192.

19. The laminate film according to claim 16 further comprising a normalized peak load impact strength in a range of from 10 N/mil to 15 N/mil (0.39 N/micron to 0.59 N/micron), according to ASTM D1792.

20. The laminate film according to claim 16 further comprising:
a machine direction Elmendorf tear value less than 150 g; and
a ratio of a transverse direction Elmendorf tear strength of the multilayer film to a machine direction Elmendorf tear strength of the multilayer film greater than 2, Elmendorf tear strength measured according to ASTM D1922.

21. The laminate film according to claim 16 further comprising a weakening line located in at least one of the multilayer film and the sealing film.

22.-24. (canceled)

25. A laminate film comprising:
the multilayer film according to claim 12;
a sealing film comprising a sealing layer; and
an adhesive layer located between the multilayer film and the sealing film.

26. The laminate film according to claim 25 wherein:
the adhesive layer is in direct contact with the multilayer film;
the adhesive layer is in direct contact with the sealing film; and
the bond strength when separating the multilayer film from the sealing film is greater than 200 g/in, as measured using ASTM F904.

27. The laminate film according to claim 25 wherein the sealing film has a normalized peak load impact strength of less than 0.5 N/micron, according to ASTM D7192.

28. The laminate film according to claim 25 further comprising a normalized peak load impact strength in a range of from 10 N/mil to 15 N/mil (0.39 N/micron to 0.59 N/micron), according to ASTM D1792.

29. The laminate film according to claim 25 further comprising:
a machine direction Elmendorf tear value less than 150 g; and
a ratio of a transverse direction Elmendorf tear strength of the multilayer film to a machine direction Elmendorf tear strength of the multilayer film greater than 2, Elmendorf tear strength measured according to ASTM D1922.

30. The laminate film according to claim 25 further comprising a weakening line located in at least one of the multilayer film and the sealing film.
